(19) United States
(12) Patent Application Publication
(10) Pub. No.: US 2015/0095105 A1
(43) Pub. Date: Apr. 2, 2015

(54) INDUSTRY GRAPH DATABASE

(71) Applicant: Matters Corp, Issaquah, WA (US)

(72) Inventor: Joseph David Fitts, Issaquah, WA (US)

(73) Assignee: Matters Corp, Issaquah, WA (US)

(21) Appl. No.: 14/043,777

(22) Filed: Oct. 1, 2013

(51) Int. Cl. G06Q 30/02

(52) U.S. Cl. CPC G06Q 30/0201
USPC 705/7.29

(57) ABSTRACT

Information may be extracted from a variety of source materials and mapped onto elements of a graph topology representative of industry information. The topology may comprise information indicative of industries and companies including partnerships, capabilities, products, solutions, and promotions. The topology may describe interrelationships between elements. Various qualities such as position within an industry, partnerships, promotions, technological and organizational capabilities, products and solutions, and so on may be quantified by examination of relationships within the industry graph topology. Quantified and unquantified data may be used for benchmarking and to compare trends. Information sets may be extracted by searching and/or traversing the industry graph topology.

### BACKGROUND

Databases of industry information may typically consist of collections of company information organized into lists and tables. Information about a company might, for example, be stored as a row in a database table. The information might represent a snapshot of the company at a particular point in time, and include information such as the size of the company, its annual sales numbers, standard industrial classification (“SIC”) codes, and so forth. Information about trends and relationships the company is subject to or involved in may not be available. If it is, the trend and relationship information might typically be provided in the form of a report written by an industry analyst. Reports such as this may be expensive and slow to produce. In some cases, the information they provide may be out of date by the time the report is written.

### BRIEF DESCRIPTION OF THE DRAWINGS

The drawings provided herein are intended to illustrate example embodiments and should not be construed as limiting the scope of the present disclosure.

FIG. 1 is a block diagram depicting graph topology information relative to a company or organization.

FIG. 2 is a block diagram depicting an example of an industry graph topology.

FIG. 3 is a block diagram depicting an example of an industry graph topology and calculating score information based on an industry graph topology.

FIG. 4 is a block diagram depicting an example of traversing an industry graph topology.

FIG. 5 is a block diagram depicting an embodiment for populating and maintaining information in an industry graph topology.

FIG. 6 is a flowchart depicting an embodiment for determining a capability score for a company or other organization.

FIG. 7 is a flowchart depicting an embodiment for determining an industry score for a company or other organization.

FIG. 8 is a flowchart depicting an embodiment for determining a company position score based in part on a composite of score values.

FIG. 9 is a flowchart depicting an embodiment for using search statistics to report on trend information for entities described by an industry graph topology.

FIG. 10 is a flowchart depicting an embodiment for recording and using historical score information to report on trends in data contained by an industry graph topology.

FIG. 11 is a block diagram depicting an embodiment of a computing environment in which aspects of the present disclosure may be practiced.

FIG. 12 is a block diagram depicting an alternative view of an embodiment of a computing environment in which aspects of the present disclosure may be practiced.

### DETAILED DESCRIPTION

Embodiments may comprise a database representative of a graph topology of industry information that enables analysis of facts, trends, and/or relationships within an industry. Information may be extracted from a wide variety of source materials and mapped onto elements of the industry graph topology. The topology may include information such as industries, companies, partnerships, promotional activities, technological and organizational capabilities, products and solutions, and so on. Information regarding marketing material or assets such as flyers, brochures, videos, educational material and so on may be included, as well as various marketing assets. Personnel information and events such as hiring trends, recent hires, recent departures, talent pools, and so forth may be included. Membership or other relationships to professional organizations, standards bodies, and so forth may also be reflected in an industry graph topology. In addition, various qualities such as position within an industry, partnerships, promotions, technological and organizational capabilities, products and solutions, and so on may be quantified by examination of relationships within the industry graph topology. Quantified and unquantified data may be used to benchmark and compare companies, industry segments, product segments, products, solutions, organizational capabilities, and so forth. Trends over time may also be recorded and analyzed. Information sets may be extracted by searching and/or traversing the industry graph topology.

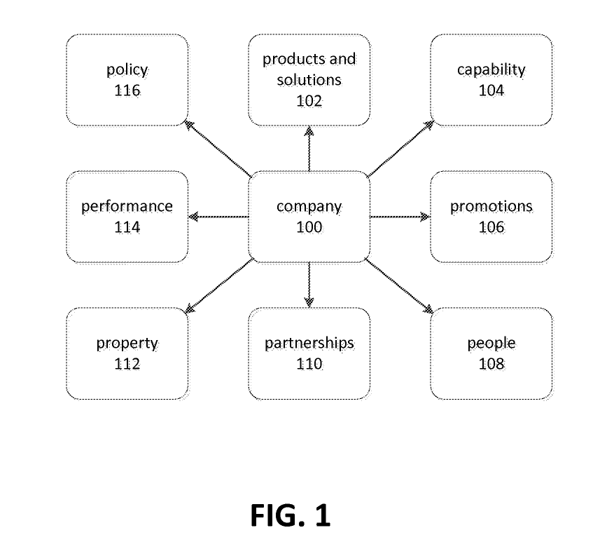

In various embodiments, an industry graph topology may comprise sets of information indicative of a company or other organization's relationships to industry. FIG. 1 depicts the sets of information that may represent a company or organization in an industry graph topology. Company 100 represents information about a company or other organization. Related to company 100 are various other sets of information.

Products and solutions 102 may represent various products or services made or sold by company 100. It may also include integration or value-added services provided by company 100 with respect to another product or service provided by the same or a different company. Data pertaining to products and solutions 102 may originate with press releases, whitepapers, product documentation, published reviews, contracts, company news, and so on. Manual or automated means may be employed to process this data, including the use of human curators or subject matter experts. Alternatively, various text processing, natural language processing, search engines, or artificial intelligence algorithms may be employed.

Capability 104 represents the technological or organizational ability of company 100. It may include the technological areas that company 100 has developed, or those that it participates in. Data pertaining to capability 104 may originate from press releases, whitepapers, product documentation, awards, certifications, employee skills or education, assets pertaining to the capability, and so forth.

Promotions 106 represents the marketing activities of company 100. Data pertaining to promotions 106 may originate with published advertisements, press releases, marketing data, and so forth. Data indicative of promotions may comprise activities, practices, events, collateral, assets, and so forth that are related to marketing. Business development and/or go-to-market activities may be included in an industry graph topology, and may be classified as such. This type of information may also be associated with relevant products, organizations, partnerships, and so forth.

People 108 represents the employees, individual contractors, managers, directors, and so forth of company 100. Data pertaining to this area may be obtained from sources such as published job listings, press releases, and so on. Information related to people may include skills, human resources, education, certifications, credentials, roles, job function, and so forth. Information indicative of talent acquisition, attrition, and migration may also be captured. In some embodiments, this information may be reflective of these events over time, so that trends for the organization, its industry, or the industries it serves may be observed or quantified.

Partnerships 110 represents companies and organizations related to company 100 through joint ventures, alliances, collaborations, and so forth. Data pertaining to partnerships may originate from announcements, press releases, contracts, business development activities, go-to-market activities, and so on.

Property 112 represents various forms of property owned or rented by company 100. This may include real property, intellectual property, goodwill, and so forth. Various non-limiting examples include factories, office buildings, data centers, equipment, patents, trademarks, licensing agreements, domain names, and so forth. Information pertaining to this category may originate in places such as county records, press releases, annual reports, public records, registries, agency filings, and so on.

Performance 114 represents various metrics indicative of the financial performance of company 100. Data pertaining to performance 114 may originate in various places, including regulatory filings such as annual reports, tax filings, and so on.

Policy 116 represents the legal and regulatory framework related to the activities of company 100. Data pertaining to policy 116 may originate with public information sources, press releases, news reports, and so on.

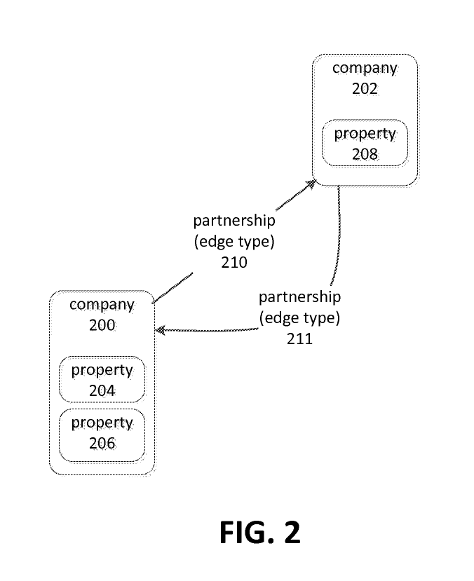

Embodiments may map information sets such as those depicted in FIG. 1 to a graph ontology. FIG. 2 provides one example of a graph ontology. The depicted scenario involves two companies 200 and 202 related to each other through a partnership 210.

The graph ontology depicted by FIG. 2 may be stored within a graph structure or graph database system. A graph database system may be viewed as consisting of nodes and edges. A node may be used to represent real or conceptual entities such as products, services, companies, promotions, and so on. Relationships between nodes may be expressed by edges. For example, in FIG. 2, company 200 and company 202 are linked by an edge 210 representing a partnership between the two companies. Edges may be unidirectional or bidirectional. Embodiments may also employ a plurality of unidirectional or bidirectional edges between nodes, as reflected in FIG. 2 by edges 210 and 211.

Both nodes and edges may have an associated type, label, and/or identifier. Nodes and edges may also have associated properties. Embodiments may treat types, labels, and identifiers as distinct entities. However, the term properties as used herein encompasses type, labels, or any other attribute associated with a node or an edge. A node representative of company 200 might comprise properties 204 and 206, while a node representative of company 202 might comprise property 208. Similar, an edge corresponding to partnership 210 might also contain various properties.

The term entry may be used to define a node or an edge in a graph database. Embodiments may employ various combinations of nodes and edges to achieve similar effects. For example, in some embodiments a partnership could be described primarily as a node, while in others the same partnership could be described as an edge. Various other permutations are possible. For example, a node could represent a partnership as a legal entity, while edges represent the relationship between various organizations that comprise the partnership. Non-limiting examples of information that may be stored as a node or edge entries includes company, organization, partnerships, market segment served, promotions, products, solutions, geographic area served, and so on. Relationships between elements may also be stored as node or edge entries.

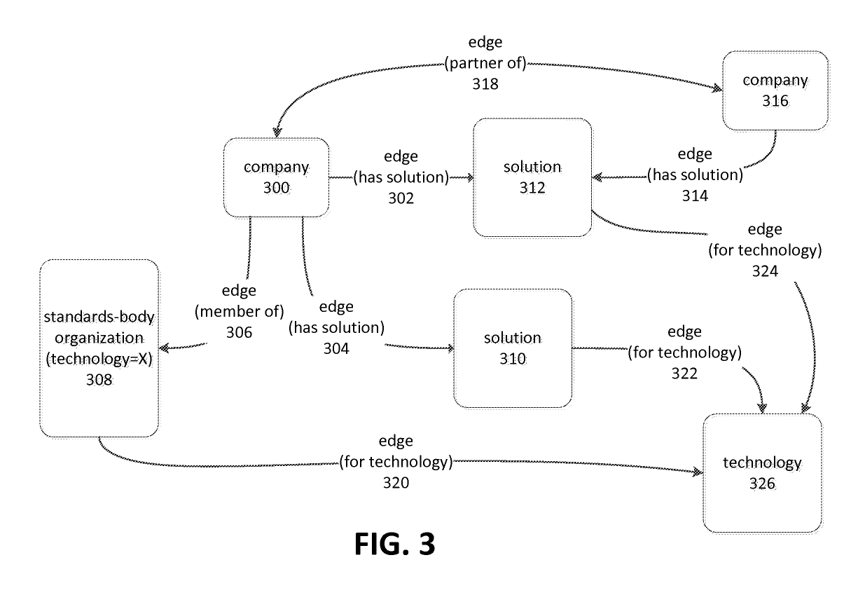

A scoring mechanism may be employed to reduce various factors to values that can be employed to search and filter the ontology. FIG. 3 depicts data in an industry graph topology to which scoring could be applied. For illustrative purposes, a score could be generated for companies in the ontology with respect to each company's capability in industry “X.” One means of generating the score is to traverse graph entries emanating from each company as they pertain to the technological area. For example, company 300 might be associated with various edges, some of which might indicate a relationship to a technological area. In FIG. 3, edges 320, 322, and 324 lead from various nodes to technology node 326. In some embodiments, edges might be used to indicate a relationship to a particular technology, rather than using a node such as technology node 326. Properties may also be used in a similar manner. A count of related nodes and edges may provide insight into the capability of company 300 regarding technology 326. Obtaining such a count may involve traversing the graph to locate a node or edge that is indicative of the technology. For example, by traversing various edges leading from company 300, a count of distinct paths leading to technology 326 may be obtained. The traversal may be attenuated by various factors, such as passing through a separate organization.

A similar count might be calculated for company 316, which in FIG. 3 is connected to technology “X” because of edge 314, solution 312 and its partnership, via edge 318, to company 300. In some embodiments, a weighting of attributes or properties of nodes or edges, relative to each other, may be used to provide insight into the capability of company 300. The weighting of attributes may be based on an assessment of the relative value of an attribute or property relative to other attributes or properties, and/or to other organizations in the industry graph topology. Various steps for normalization and weighting might be applied to account for factors such as the relative importance of various entries in the graph. Computed scores for company 300 and company 316 might then be compared to determine that, for example, company 300 has greater capabilities in industry “X” than does company 316. Scores may also be calculated with respect to application of additional or alternative techniques, such as rule-based systems, decision trees, neural network methods, and so on. Additional or alternative metrics may also be employed, such as those based on the distance between nodes and the types of nodes or edges that are traversed.

Information may be retrieved from an industry graph topology through a traversal of nodes and edges contained within it. A traversal may begin by locating a starting position, such as a node, and navigating to connected edges and nodes. The navigation may be limited by various criteria and navigation instructions, such as only navigating through edges having property values falling within a specified range. During the traversal, information may be extracted and accumulated into a result set.

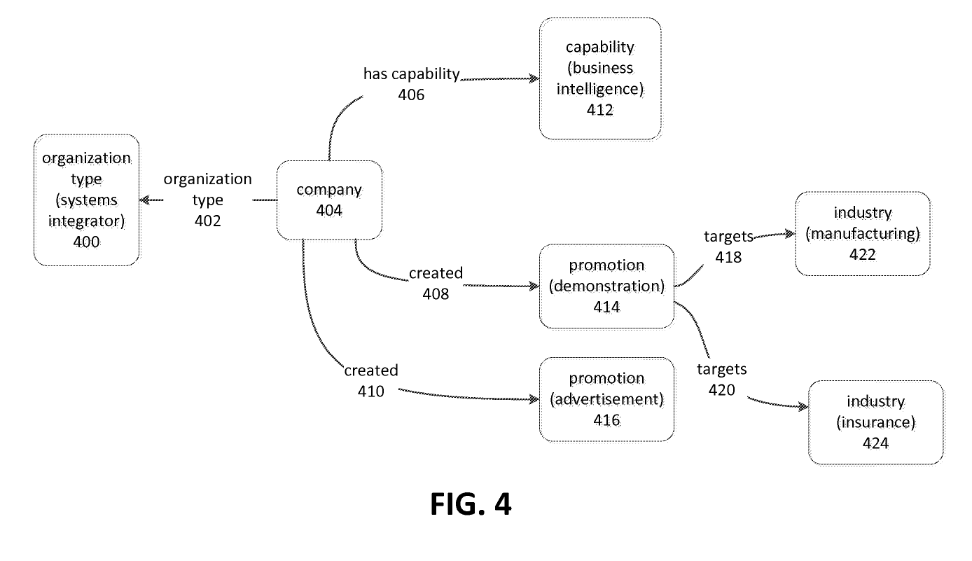

FIG. 4 depicts an example of traversing an industry graph topology using an embodiment of the present disclosure. For illustrative purposes, the traversal may be assumed to be related to a query attempting to find demonstrations targeting the insurance industry provided by systems integrators having business intelligence capabilities. The traversal may begin by locating entries in an industry graph ontology corresponding to companies, such as company 404, that are related to a systems integrator organization type 400. This relationship may, in some embodiments, be represented by an edge indicative of a relationship to an organization type 402 leading to organization type 400. There may be many such entries in an industry graph topology, although for clarity in representation only one is depicted in FIG. 4. For the same reason, only one company is depicted in FIG. 4 although many may be present in an industry graph topology.

Embodiments may examine entries for relevance to the traversal and desired result set. For example, in FIG. 4 company 404 is associated with edges 406, 408, and 410. One of these edges 412 indicates that company 404 has business intelligence capability. Accordingly, this company might be included in the final result set assuming other criteria are met. Relevance to a traversal or desired result set may be based, at least in part, on having connectivity in the graph to a desired feature, possibly limited by certain node or edge types, or based on distance. Relevance to a traversal or result set may also be based on examination of properties attached to an edge or node. In the example of FIG. 4, other companies may have been disregarded based on not being linked to a business intelligence capability, or due to not having properties indicative of business intelligence capabilities.

A traversal may involve examining various nodes or edges but removing them from further consideration. For example, edge 410 leads to node 416 involving an advertising promotion. Because the desired results involve demonstration promotions, edge 410 and node 416 can be removed from further consideration. However edge 408 leads to node 414 which involves a demonstration promotion, and may therefore be considered for possible inclusion in the result set, or for further traversal. Edge 418 and node 422 may be discarded because edge 418 leads to a node 422 representing the manufacturing industry rather than the insurance industry. Node 414 satisfies the desired criteria for the traversal, namely demonstrations targeting the insurance industry by systems integrators with business intelligence capabilities. Nodes may therefore be considered for inclusion in a result set based on having edges with desired properties or having edges leading to nodes with desired properties. In addition, nodes may be excluded based on distance between nodes, or based on an intervening node or edge having an undesired property.

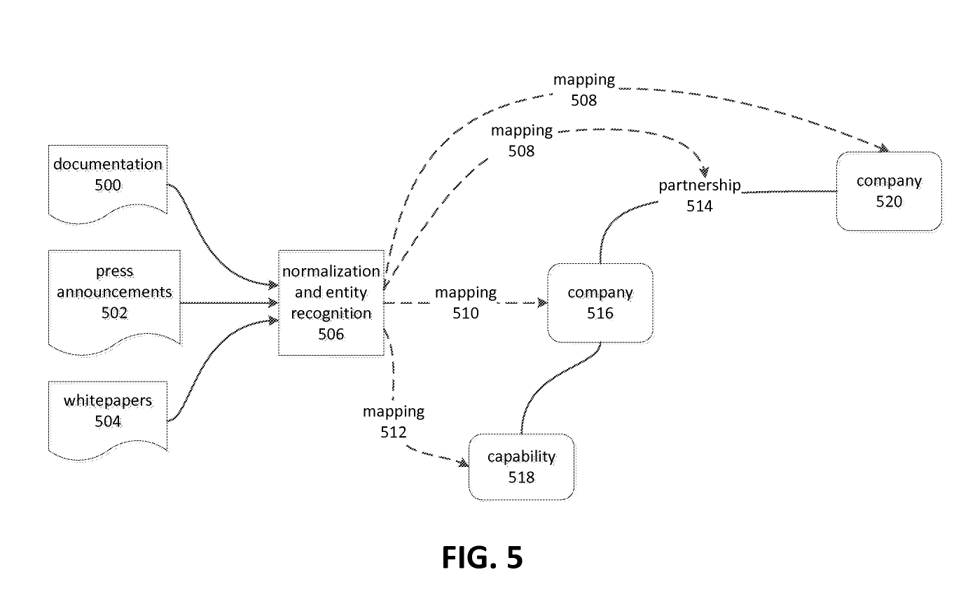

FIG. 5 depicts a process of populating and maintaining information in an industry graph topology. Various forms of information, such as documentation 500, press announcements 502, whitepapers 504, and so forth may be acquired through a variety of automated and manual approaches.

A mechanism for information extraction, normalization, and entity recognition may be applied to acquired information, as represented by element 506. Extraction may comprise extracting terms, phrases, numerical values, and other forms of information from various documents and other information sources received or retrieved for processing. The term documents may comprise a wide variety of physical or electronic documents processed by automated and/or manual processes. Non-limiting examples of documents include web pages, portable document format (“PDF”) files, word-processor documents, spreadsheets, text messages, e-mails, pamphlets, brochures, manuals, whitepapers, and so forth. Normalization may comprise various forms of canonicalization, stemming, broadening, conflation, lemmatization, and so forth. Normalization may be performed as a precursor to entity recognition. Entity recognition may involve various operations performed to store extracted and normalized data at appropriate locations within an industry graph topology. This may comprise recognizing information as corresponding to a known entity, such as an organization, capability, industry, industry segment, location, and so forth. Various approaches may be employed, including those referred to regarding normalization as well as natural language processing, rule-based engines, logic programming, and so forth. A mapping process may be employed, which may comprise performing lookups in a taxonomy or locating a position in an industry graph topology to determine correspondence between an identified entity and a node, edge, attribute, or property in an industry graph topology.

Normalized and recognized entities, as well as relationships between entities, may be mapped to entries in an industry graph topology. In FIG. 5, this is depicted by mappings 508, 510, and 512 showing that normalized and recognized entities may be mapped to nodes and edges in an industry topology graph. For example, in FIG. 5, mapping 508 illustrates a mapping of a normalized and recognized entity to an edge 514 which is representative of a partnership. Similarly, mappings 510 and 512 show application of a mapping to company 516 and capability 518. Mapping may comprise storing one or more nodes and/or edges to an industry graph topology and establishing interrelationships between nodes and edges within the topology. As depicted by the two arrows of mapping 508, a mapping may correspond to the addition of multiple nodes and edges, for example by establishing a partnership relationship between company 516 and company 520 via edge 514.

Embodiments may recompute scores associated with industry graph topology entries after new data has been updated. Recomputation may be limited to a region of an industry graph topology containing new or modified entries. Score calculation may involve nodes and edges several steps removed from the immediately affected entries. Accordingly, the size of the region may be enlarged several degrees beyond those entries immediately affected.

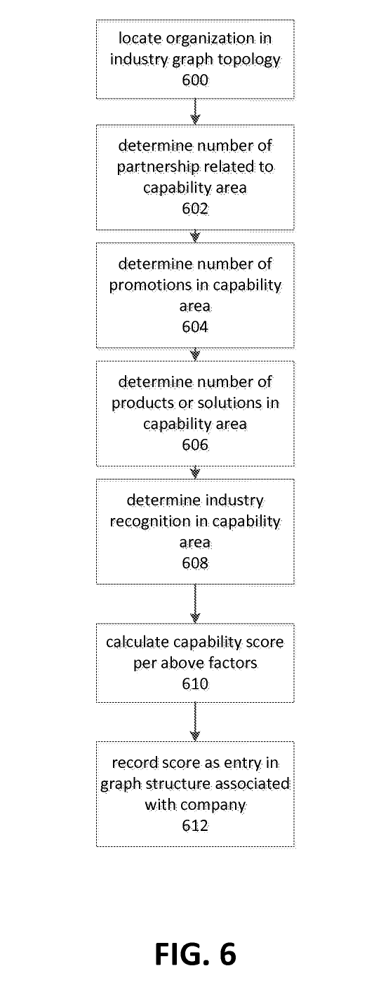

FIG. 6 depicts an embodiment of a process for determining a capability score. A capability score may be determined, by some embodiments, to provide information indicative of a company or other organization's capability within a technological area. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Operation 600 depicts locating, within an industry graph topology, an organization for which a capability score is to be computed. This may comprise a traversal of an industry graph topology seeking the relevant entry or entries. Embodiments may employ indices or similar mechanisms. Embodiments may perform score computations on all companies within a region of an industry graph topology based on knowledge of regions affected by data that has been recently added or modified.

Operation 602 depicts determining a number of partnerships between a company and other companies where the partnerships are related to the capability area. In addition to or instead of a count of the number of partnerships, other numeric or non-numeric metrics indicative of the quality or extent of the partnerships may be employed. This may include numeric values as well as non-numeric values such as letter grades or other textual classifications.

In various embodiments, a weighting function may be applied to a set of attributes associated with each partnership to determine a quality of the partnership, and that value may be added to or averaged with those of other partnerships. The importance of each partnership may also be weighted with respect to each other. Embodiments may also utilize information indicative of the organizations involved in the partnership, such as a company's leadership position within an industry, the size of the company, the number of partnerships the company is involved in, and so forth. A partnership or other joint endeavor may be indicative of technological strength in the capability area, and thus a partnership represented in an industry graph topology may be used as a factor in computing capability scores for the organizations involved.

Partnership quality may be based, in some embodiments, by a number of credentials, specializations, certifications, awards, products, demonstrations, or other entities or events associated with companies in the partnership. The quality of these factors may also be incorporated, for instance by weighting the factors relative to each other. For example, prestigious industry awards may be weighted more heavily than minor awards.

In some embodiments, the directionality of the partnership may be considered. In some cases partnerships may involve one organization contributing technological expertise that is lacking amongst other organizations in the partnership. Accordingly, the organization that is contributing technological expertise could have its capability score for that technological area increased, while the scores for other organizations in the partnership could be unaffected.

Embodiments may also include a count of the number and/or quality of promotions or other events in a determination of a capability score. Operation 604 depicts determining the number of promotions that an organization has undertaken, related to the capability for which the score is being determined. The determination may involve traversing from a node representative of the organization or organizations of interest to nodes representative of promotions, where the traversal is limited by the technological capability of interest.

Operation 606 depicts determining the number and/or quality of products or solutions provided by an organization whose score is being determined. This operation may comprise products or solutions directly provided by the organization, or provided through a partnership.

Operation 608 depicts determining industry recognition in a capability area. Industry recognition may comprise awards and other forms of acknowledgement of an organization's abilities in a capability area. Recognition may be derived from sources such as press releases and stored as nodes and/or edges in an industry graph topology. When calculating a capability score, certain awards or other forms of recognition may be weighted to adjust for difference in relevance to the technological capability being evaluated.

As depicted by operation 610, the various factors described above may be used to calculate a capability score indicative of a company or other organization's technological ability within a given field. Various additional or alternative factors not depicted in FIG. 6 may also be used. Examples include personnel, skills, credentials, awards, products, industries served, asset acquisition, equipment purchases, factories owned, and so on. Factors may be weighted and/or normalized. Embodiments may, for example, weight factors relative to each other to reflect the relative importance of each factor. Embodiments may also normalize the score to fall within a defined range, such as zero to 100. Some embodiments may map the score to a non-numeric value such as a letter grade.

Operation 612 depicts recording the calculated score within an industry graph topology, or in an external location. The score may be recorded in various ways, such as a property associated with a node or within a distinct node. Some embodiments may record scores as a node representative of a capability linked via an edge to a related company. Some embodiments may store the result within an online analytical processing cube or other dimensional store.

Various alternative methods may be employed to calculate a score, such as a capability score, industry score, and so forth. A score may be a numeric value, or may be a non-numeric value, including enumerated value such as grades or a classifications. Various aggregations may be used, such as the those incorporating counts described above. Scores based on aggregation may also be influenced by weighting, normalization, or other such approaches. Weighting may be based on the relative importance of a particular factor, by distance in the graph, or other such factors. An exponential weighting might also be employed, for example to reflect greater importance for factors that are repeated many times. For example, a company with ten times as many promotions related to a particular subject matter might be deemed to be more than ten times as concentrated in that area, relative to a company with only one such promotion. Some embodiments may employ customer-driven input, such as relative weightings of various factors. Embodiments might also employ rule-based systems to calculate a score.

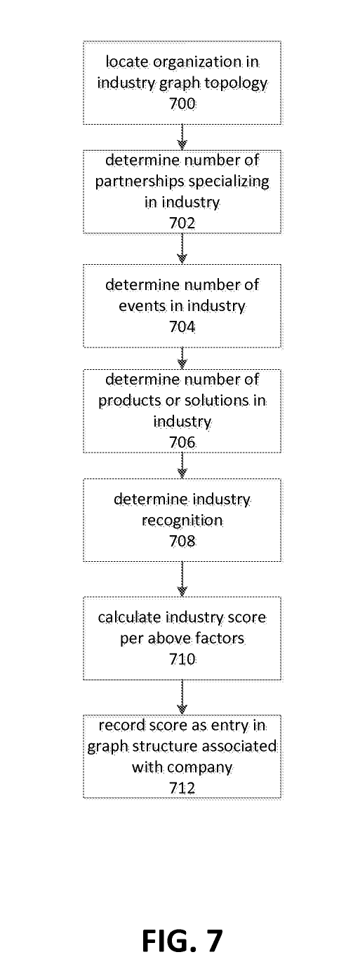

An industry score may be determined to represent a company or organization's position relative to a particular industry. FIG. 7 depicts determining an industry score. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Determining an industry score may comprise locating one or more companies or organizations for which a score is to be calculated, as depicted by operation 700. At operation 702, a count of the number of partnerships in which a given company is involved may be calculated, where the partnerships involve the organization's participating in the industry. A count of promotions or other events related to an industry may also be made, as depicted by operation 704. The number of products or solutions provided by an organization to a specific industry may also be used as a factor in determining its industry score. Operation 706 depicts determining a count of products and/or services related to the industry in question. Operation 708 may comprise determining a count of awards or other forms of industry recognition acquired by the organization.

Embodiments may determine an industry score based on these and other factors. The score may be determined based on weighted values for each factor. The score may be normalized to fall within a given range and may also be translated into another numeric value or a non-numeric value. Operation 710 depicts determining an industry score based on the factors described previously, potentially including or substituting alternate factors. Once determined, the score may be stored, as depicted by operation 712, within an industry graph topology, for example as a property associated with the corresponding company or in a node linked to the corresponding company.

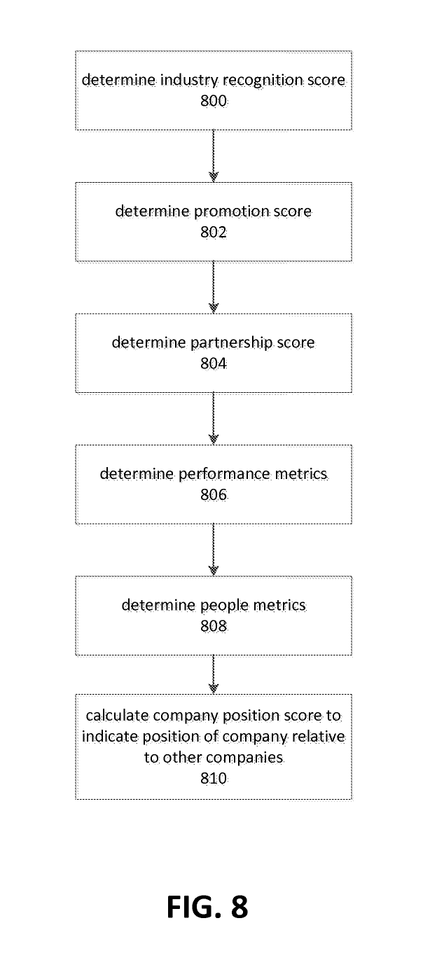

Embodiments may provide additional views of a company or organization's position by combining determined scores with additional information. FIG. 8 depicts determining a composite value indicative of company position in one or more industries. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

Various determined scores may be incorporated into a composite value indicative of company position. Operation 800 depicts determining an industry recognition score based at least in part on a count of the number of industry awards or other accolades have been presented to a company. Operation 802 depicts determining a promotion score based at least in part on a count of the number of promotion activities the company has engaged in. A count of the number of partnerships may also be determined, as indicated by operation 804. The counts determined in each of these operations may be filtered based on industries, timeframe, and other factors.

Various company performance metrics may also be utilized in determining company position, as depicted by operation 806. These include financial performance metrics such as revenue, profit, return on investment, and so forth.

Operation 808 depicts utilizing personnel metrics, such as employee counts, hiring trends, salaries, and so forth. An industry graph topology may also contain personnel information allowing for a personnel score to be calculated. For example, information indicative of prominent employees may be stored within an industry graph topology. A count of prominent employees, possibly limited to those relevant to a technological field of interest, may be used to calculate a personnel score.

Operation 810 depicts using the various factors just described, possibly including or substituting additional factors, to determine a value indicative of a company or organization's position relative to other companies or organizations. Embodiments may employ a weighted average of metrics such as industry recognition score, capability score, promotion score, partnership score, performance metrics, personnel metrics, and so on. Embodiments may normalize these values relative to an average value. Embodiments may also, based on the determined value, assign a quartile value or assign a rank such as “leader,” “challenger,” “emerging,” or “participant.”

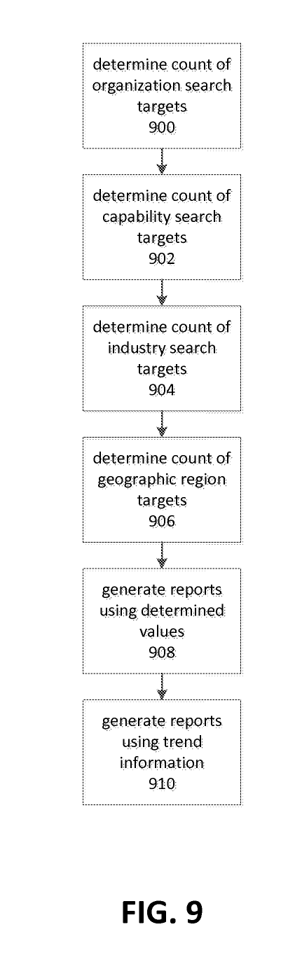

An industry graph topology may be hosted in a computing environment accessible to a large number of customers over a network such as the Internet. Embodiments may collect statistics indicative of searches performed on an industry graph topology and use those statistics to provide information. FIG. 9 depicts an embodiment of using search trend information with an industry graph topology. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel. FIG. 9 is illustrative of one of many possible embodiments for searching trend information using an industry graph topology. Embodiments may be configured to supply trend information for policies, products, solutions, capabilities, promotions, people, partnerships, properties, performance, and so on.

Operation 900 depicts determining a ranked list of organization search targets. For example, when a query is received that results in an industry graph topology being searched for a particular company, embodiments may increment a counter, or other stored value, indicative of that company. Embodiments may utilize a property associated with a node representative of the company to store the value. The value may also be incremented in conjunction with executing a query or other traversal of an industry graph topology.

Values indicative of other search targets may be incremented in the same or similar fashion. Operation 902 depicts determining the most popular capability search targets. Other targets that may be determined include the most popular industry search targets as depicted by operation 904, and the most popular geographic region targets as depicted by operation 906. Embodiments may track various statistics in addition to, or instead of, those depicted in FIG. 9. Various statistics and counter values may be stored as properties associated with entries, or as distinct entries linked to related entities.

Embodiments may display the determined values to users of an industry graph topology, as depicted by operation 908. The values may be incorporated into various reports that can be displayed or otherwise provided to users. Search trends may be indicative of emerging industries, companies, technological capabilities, and so forth. Embodiments may record search statistics over time to display trends for values such as organizational, capability, industry, and geographic region search targets. Trends may be represented as ranked lists of multiple search targets, or as a series of values indicative of searches over time for a particular target. For example, a report could describe a trend of searching for a particular company or a particular geographic region. Operation 910 depicts generating or displaying reports using search target trend information

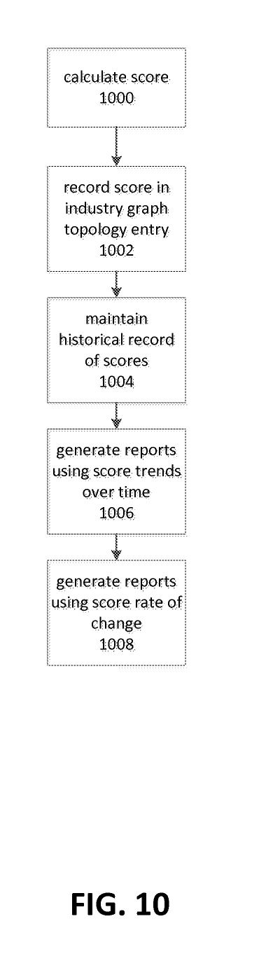

Trend information may also be recorded for score calculations. FIG. 10 depicts an embodiment of a process for recording and utilizing score trend information. Although depicted as a sequence of operations, those of ordinary skill in the art will appreciate that the depicted operations are intended to be illustrative and should not be construed as limiting the scope of the disclosure. Furthermore, those of ordinary skill in the art will appreciate that at least some of the depicted operations may be altered, omitted, reordered, or performed in parallel.

As depicted by operation 1000 and 1002, a scoring metric such as a capability score, industry score, partnership score, or promotions score may be calculated and stored. Embodiments may store scores within an industry graph topology entry. For example, an embodiment might store score information as properties on a node entry that is representative of a company.

Operation 1004 depicts maintaining score information over time. Embodiments may maintain a historical record of score calculations. As depicted by operation 1006, historical records of score calculations may be employed to view trends over time. For example, embodiments may generate a report for a company that shows how its technological capabilities have changed over time, or how often it has entered into or departed from partnerships with other companies. Operation 1008 depicts generating reports using the rates of change for scores over time. Embodiments may, for example, generate top ten lists of companies whose industry position is growing or shrinking the fastest, based on the rate at which industry scores are changing.

Embodiments may employ aspects of the present disclosure for identifying, analyzing, comparing, benchmarking, recommending and/or monitoring organizations within an industry. This may comprise identifying competitors, determining organizational capabilities, industry focus, industry position, and geographic footprint.

Identifying competitors may comprise identifying other organizations with which an organization competes, based on similarity in organizational type, capability, and industry focus. Competitors may be identified through approaches comprising graph traversal and/or constraint solving. Human curation may be employed to refine results and verify competitors.

Organizational capabilities may be represented by a capability score or other value indicative of an organization's rank or position in a technological capability area. A capability score may be based on factors such as the number and/or quality of partnerships, promotions, solutions, and industry recognition within the capability area.

In some embodiments, an industry score may indicate which industries are targeted by an organization, e.g. the industries to which the organization's customers belong. In other words, an industry score may indicate an organization's relative strength in serving a particular industry, or that organization's concentration in serving a particular industry. An industry score may be based on the number and/or quality of partnerships, promotions, solutions, and industry recognition within the targeted industry. Industry scores may be expressed relative to other companies, or may be expressed relative to the company itself. An example of the latter case may involve expressing an organization's focus on an industry as a percentage relative to the same organization's total activities.

In other embodiments, industry position may also be indicative of an organization's position within its own industry, relative to other organizations in the same industry. Industry position may be expressed relative to an industry leader. Industry position may be based on capabilities, performance, personnel, industry recognition, promotions, and partnership. Embodiments may base industry position values or rankings based on score calculations, described herein, for factors such as industry recognition, promotions, and partnership.

Embodiments may employ aspects of the present disclosure to utilize partnership information for identifying, analyzing, comparing, benchmarking, recommending and/or monitoring organizations within an industry. Embodiments may traverse an industry graph topology to generate reports describing partnership ecosystems. Partnership ecosystem reports may be used to display partnership relationships between companies. A partnership ecosystem may be refined or filtered by applying criteria such as capabilities, industries targeted, geography, organization type, and so on.

Embodiments may also employ partnership information to analyze platform support trends across partnership ecosystems. For example, by traversing from partnerships to capabilities supported by a partnership, it may be determined which technological platforms are supported by a partnership. Embodiments may determine which platforms have or are acquiring the most support, or which platforms are growing or shrinking the fastest, based on the rate of change of partnerships within a capability area related to the platform. Embodiments may employ capability and/or partnership score trends to identify growing or shrinking platforms.

Growth areas within a partnership ecosystem may be monitored by tracking organizational types, capabilities, and geographic information, and used to report the current status and trends within the ecosystem. Reports on partnership ecosystems may include information indicative of shared or overlapping partnership between two organizations, revealing the extent to which two companies have the same set of partners.

Embodiments may be utilized to monitor and analyze promotional and go-to-market activities within an industry. A report may be defined based on one or more industries to be included in a report, possibly limited by various filters such as event name, type, and location, as well as collateral type, solutions, industry segments, geography, and date.

Embodiments of the present disclosure may be employed to monitor and analyze industry size, segmentation, and structure as related to products and solutions. Clusters of organizations may be identified by traversing an industry graph topology by dimensions such as solutions, organizational type, capabilities, targeted industry, and geographic locations. A segmentation report may be generated based on these dimensions, and may comprise industry-wide counts of products or solutions summarized by dimension or combination of dimensions. A solution share figure may also be generated, which may comprise information indicative of the number or percentage of solutions, within a segment, provided by an organization.

Embodiments may be employed to provide various insights. Benchmarks may refer to the ability to compare characteristics or trends across companies. For example, for a given company the number and/or quality of partners with a specific capability set could be compared to those of a competitor. Another example involves comparing, for a given company, the number and/or quality of partners focused on providing services to a specific industry to those of competitors. Benchmarks may be performed for a variety of characteristics or trends, such as promotions, products, solutions, performance, people, properties, and policies. Benchmarks may be viewed relative to a snapshot in time, or as a trend over time. Embodiments may, for example, compare the rate of change for a number and/or quality of partnerships with a specific capability set. Various criteria or rule sets may be applied to produce a value that can serve as the basis for comparing qualities. For example, quality could be based on factors such as the size of an organization or the length of a partnership.

Embodiments may also provide insights in the form of recommendations. Embodiments may perform one or more graph traversals to identify entries in the graph with similar characteristics, or identify entries based on factors such as user preferences, similarity to other users, or interaction patterns of the user or other users. If other users are considered, the set of other users may be restricted to similar users. Embodiments may provide recommendations for any type of entry, such as those corresponding to products, solutions, capabilities, industries, partnerships, promotions, property, and policies. Embodiments can show similar companies or other types of entries based on factors such as type, size, geography, competitors, and so forth. In one embodiment, a set of recommended companies may be based on showing that companies who partner with a particular company also tend to partner with those companies in the recommended set of companies.

To form recommendations, embodiments may examine similarity of relationships between two or more graph regions, each region consisting of an entry and a set of related nodes and edges. Another possibility is to record indications that a particular entry is of interest to the user or to other users. The indications may be related to direct user action, or based on various forms of interaction undertaken by a user. For example, queries performed by the user or similar user may be used as the basis for indicating that an entry is of interest to a user. Embodiments may mark entries during graph traversal to indicate that an entry has been visited, how many times an entry node has been visited, how recently an entry has been visited, and so forth.

Embodiments may provide another form of insight by facilitating the analysis of trends. For example, embodiments may provide reports indicative of the growth of a characteristic such as the number of partnerships, the number of employees, and so on. Growth of partnerships, promotions, products, solutions, partnerships, people, property, and so forth may be reported on. Another trend that may be analyzed involves migration. For example, migration of employees from one organization to another might be reported. Other examples involve migration of partnerships or property.

Another form of insight involves a company's share across an industry or market. Share may be reflective of capabilities, industries served, partnerships, promotions, products, solutions, performance, people, property, or policy. One example involves the number and/or quality of partners with a capability in a specific technological area, expressed as a percentage of the total number and/or quality of organizations with capability in that area, within the relevant industry.

Yet another form of insight involves what may be described as a conversion gap. This may be described as a measure of a company's partners specialized or certified with a technological capability related to that company, as compared to the total number of their partners who have these capabilities, but are not yet specialized/certified with that company. For example, consider a software company that provides a platform or operating system and partners with companies who develop solutions on that platform to address particular customer needs—supply chain management solutions, for instance. The company has 10 partners which have attained the supply chain management specialization or certification with that company, so are thus supply chain management capable organizations. However, the company also has another 10 partners who are not yet supply chain management certified with them, but are in fact supply chain management capable companies. In this case, the company may be described as having a 50% conversion gap for supply chain management partners. Conversion gaps may be analyzed for other measures, such as capabilities, industries served, products, solutions, policy, promotion and property.

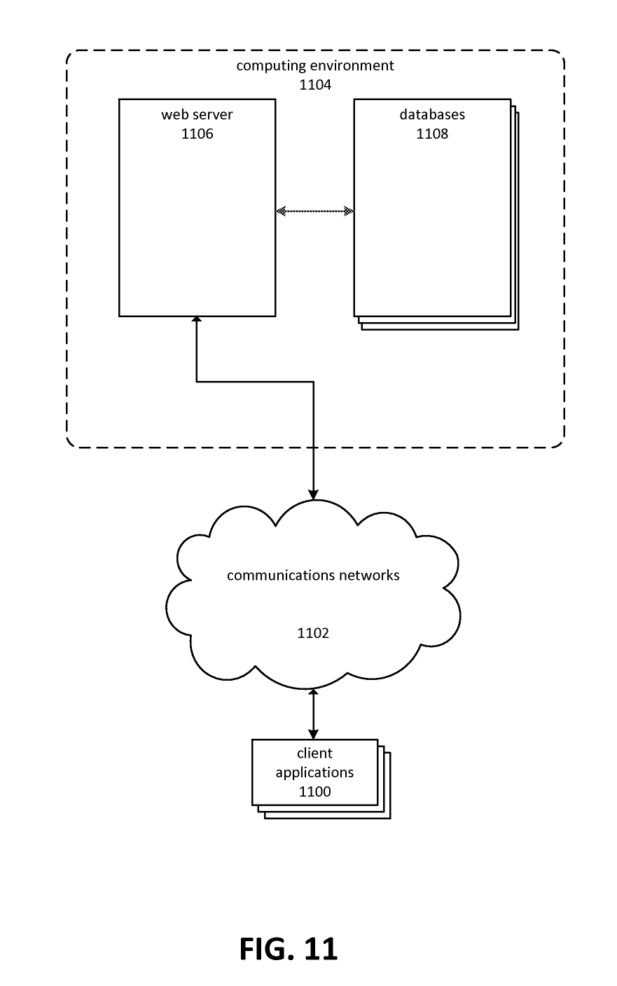

Embodiments of the present disclosure may comprise the elements depicted in FIG. 11. Various client applications 1100 may access systems and components, such as web server 1106, comprising computing environment 1104. Communication between client applications 1100 and computing environment 1104 may involve one or more communications networks 1102 such as local area networks, the Internet, and networks internal to computing environment 1104.

Client applications 1100 may operate on various devices such as personal computers, smartphones, tablets, and so forth. Client applications 1100 may comprise executable instructions performed by a processor on a device, the instructions operable to interact with components in computing environment 1104 such as web server 1106. Web server 1106 may be configured to receive requests from one or more client applications 1100 to query data stored in an industry graph topology, or to generate reports based at least in part on an industry graph topology. Web server 1106 may interact with one or more of databases 1108. Databases 1108 may be configured to operate one or more database systems, and may comprise one or more relational database management systems or non-relational database management systems such as no-structured query language (“NoSQL”) databases, graph databases, object-oriented databases, dimensional databases, and so forth. Database management systems may be distributed among multiple computing nodes. For example, collections of data may be horizontally or vertically partitioned so that each computing node hosts a portion of a collection of data. In a graph database management system, portions of the graph may be hosted on individual computing nodes.

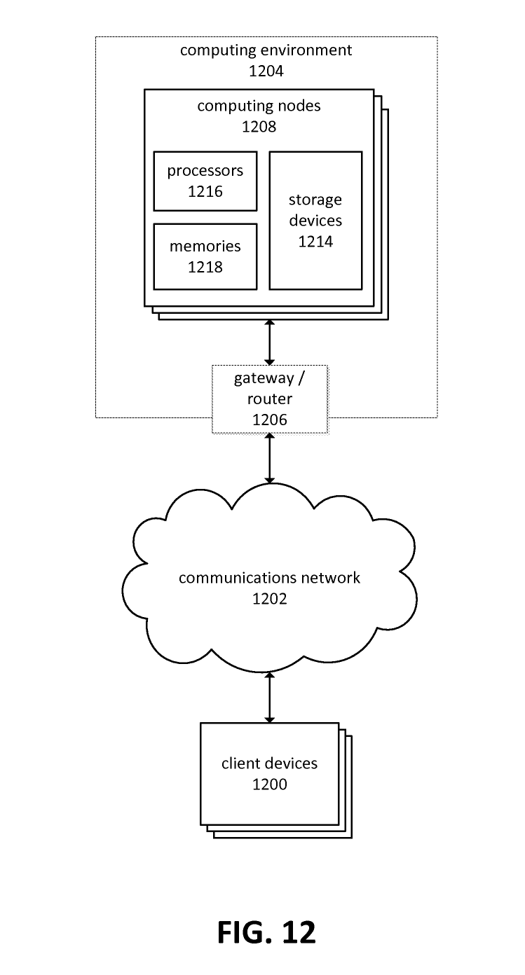

FIG. 12 provides an alternative view of an embodiment of a computing environment 1204. Web servers, databases, and other components may operate on computing nodes 1208 within computing environment 1204, which may for example comprise a data center, cloud hosting service, and so forth. Computing nodes 1208 may comprise processors 1216 coupled to one or more memories 1218 and storage devices 1214 which are operable to store and retrieve data from various forms of non-transitory computer-readable storage media. One or more client devices 1200 may communicate with elements of computing environment 1204 via communications network 1202 and gateway/router 1206. In some embodiments, computing nodes 1208 may comprise virtual machines sharing physical computer hardware.

The various processes, methods, and algorithms described herein may be embodied in various combinations of general-purpose and application-specific circuitry. The processes, methods, and algorithms described herein may be embodied in whole or in part by code modules executed by one or more processors of a computing system. The code modules may be stored on any type of non-transitory computer-readable storage medium, such as magnetic disk drives, optical disk drives, solid-state memory, random-access memory, read-only memory and so forth. Some or all of the code modules may be transferred between various memories and storage devices for various purposes, such as memory management by a computer operating system. In various embodiments, processes, code modules, and other elements may be distributed among multiple computing systems communicating via a computer network or other communications method. The results of the various processes, methods, and algorithms described herein may be stored in any type of non-transitory computer storage including volatile and non-volatile memory.

Aspects of the embodiments described herein may be used independently of one another, or combined in a variety of ways. All possible combinations and sub-combinations are intended to fall within the scope of the present disclosure. Various blocks or elements depicted in the figures may be added, removed, rearranged, or reconnected in various ways to form alternative embodiments. The embodiments described herein have been provided as examples, and are not intended to limit the scope of the present disclosure. Nothing in the description provided is intended to imply that any particular feature, characteristic, operation, step, block, or other element is required.

Conditional language such as “can,” “could,” “may,” “might,” “for example,” and so on is generally intended to convey that some embodiments include the recited element while other embodiments do not. Accordingly, unless specifically stated otherwise or required by context, such language is not intended to imply that the recited element is a mandatory component of any particular embodiment. The terms “comprising,” “having,” “including” and so forth do not exclude additional elements. When the term “or” is used to connect a list of elements, it is used inclusively to refer to one or more of the elements of the list.

What is claimed:

1. A system comprising:
one or more computing systems configured to store data on one or more storage devices, the data representative of a graph topology of industry information, at least one of the one or more computing systems configured at least to:
store a first entry on the one or more storage devices, the first entry comprising information representative of a first company;
store a second entry on the one or more storage devices, the second entry comprising information representative of a second company;
store a first one or more additional entries on the one or more storage devices, the first one or more additional entries comprising a first information indicative of one or more relationships of the first company with at least one of a partnership between the first company and other companies, a capability of the first company, a market segment served by the first company, a promotion undertaken by the first company, a product provided by the first company, a solution provided by the first company, or a geographic region;
store a second one or more additional entries on the one or more storage devices, the second one or more additional entries comprising a second information indicative of one or more relationships of the second company with at least one of a partnership, capability, market segment, promotion, product, solution, or geographic region; and
determine a position of the first company with respect to the second company, based at least in part on comparing the first information indicative of one or more relationships of the first company with the second information indicative of one or more relationships of the second company.

2. The system of claim 1, at least one of the one or more computing systems further configured at least to:
determine a metric for the first company with respect to a technological or organizational capability, the metric based at least in part on a count of the first one or more additional entries that are indicative of partnerships between the first company and additional companies that involve the capability.

3. The system of claim 1, at least one of the one or more computing systems further configured at least to:
determine a metric for the first company with respect to a technological or organizational capability, the metric based at least in part on a count of the first one or more additional entries that are indicative of products or solutions provided by the first company that involve the capability.

4. The system of claim 1, at least one of the one or more computing systems further configured at least to:
determine a metric for the first company with respect to a geographic area, the metric based at least in part on a count of the first one or more additional entries that are indicative of the geographic area.

5. The system of claim 1, at least one of the one or more computing systems further configured at least to:
retrieve a first metric and a second metric from the one or more storage devices, the first metric determined with respect to a dimension comprising one or more of partnerships, technological or organizational capabilities, market segments, products, solutions, or geographic regions, the second metric determined, at a later point in time, with respect to the dimension.

6. The system of claim 1, at least one of the one or more computing systems further configured at least to:
retrieve a first at least one entry from the one or more storage devices, the first at least one entry satisfying a first criteria applicable to a first dimension, the first at least one entry related to a second at least one entry satisfying a second criteria applicable to a second dimension.

7. The system of claim 1, at least one of the one or more computing systems further configured at least to:
locate the second entry representative of the second company based at least in part on an entry in the first one or more additional entries indicative of a partnership between the first company and the second company.

8. The system of claim 1, at least one of the one or more computing systems further configured at least to:
locate an entry in the first one or more additional entries, the located entry representative of a product or solution provided by the first company, the located entry related to the second entry representative of the second company by an entry representative of a partnership between the first company and the second company.

9. The system of claim 1, wherein at least one of the one or more computing devices is configured to operate a graph database management system.

10. The system of claim 1, at least one of the one or more computing systems further configured at least to:
form a set of recommended entries, of the second one or more additional entries, based at least in part on a degree of similarity between the first information and the second information.

11. A method of analyzing industry information, the method comprising:
storing a first entry on one or more storage devices connected to one or more computing devices, the first entry representative of a first company;
storing a plurality of additional entries on the one or more storage devices, the plurality of additional entries comprising information indicative of a first one or more relationships between the first company and at least one of a partnership, capability, market segment, promotion, product, solution, or geographic region; and
determining, by at least one of the one or more computing devices, a position of the first company within an industry, based at least in part on a first value indicative of the first one or more relationships and a second value indicative of a second one or more relationships between a second entry representative of a second company and at least one of a partnership, capability, market segment, promotion, product, solution, or geographic region.

12. The method of claim 11, further comprising:
locating, by at least one of the one or more computing devices, a subset of entries on the one or more storage devices, the subset of entries conforming to a criteria for selecting at least one of a partnership, capability, market segment, promotion, product, or solution.

13. The method of claim 11, further comprising:
comparing, by at least one of the one or more computing devices, the position of the first company with a second position of the first company within the industry, the second position calculated with respect to a later point in time.

14. The method of claim 11, further comprising:
storing, on the one or more storage devices, a first metric indicative of a number of entries stored on the one or more storage devices, the entries indicative of one or more of a partnership between the first company and one or more additional companies, a technological or organizational capability of the first company, a market segment served by the first company, and/or a promotion undertaken by the first company.

15. The method of claim 14, further comprising:
locating an entry indicative of the second company, the locating based at least in part on comparing the first metric with a second metric, the second metric based at least in part on a number of entries stored on the one or more storage devices that are indicative of one or more of a partnership between the second company and one or more additional companies, a technological or organizational capability of the second company, a market segment served by the second company, and/or a promotion undertaken by the second company.

16. The method of claim 11, further comprising:
receiving a query involving the first entry; and
incrementing a counter stored on the one or more storage devices, the counter indicative of a number of received queries that have involved the first entry.

17. The method of claim 11, wherein the information indicative of a first one or more relationships comprises an edge in a graph database structure.

18. The method of claim 11, wherein the first value is based at least in part on a count of the first one or more relationships.

19. The method of claim 11, wherein the first value is based at least in part on a relative importance of a first relationship of the first one or more relationships with respect to other relationships of the first one or more relationships.

20. The method of claim 11, further comprising:
comparing the first one or more relationships to the second one or more relationships, the comparing based at least in part on at least one of a count of relationships, a quality of relationships, or a rate of change of the count of relationships or the quality of relationships.
